(19) United States
(12) Patent Application Publication
(10) Pub. No.: US 2002/0055179 A1
(43) Pub. Date: May 9, 2002

(54) Ultrahigh throughput fluorescent screening

(76) Inventors: Hugh W. Busey, Cheshire, CT (US); Thomas W. Astle, Orange, CT (US)

Correspondence Address: JOHN H CROZIER, 1934 HUNTINGTON TURNPIKE, TRUMBULL, CT, 06611

(21) Appl. No.: 09/812,102

(22) Filed: Mar. 19, 2001

Related U.S. Application Data
(60) Provisional application No. 60/190,189, filed on Mar. 17, 2000.

(51) Int. Cl. G01N 21/64

(52) U.S. Cl. 436/172; 436/164; 422/99; 422/104

(57) ABSTRACT

The present invention achieves the above objects, among others, by providing, in a preferred embodiment, an ultrahigh throughput fluorescent screening apparatus for a microplate having a plurality of vertical sample wells, the apparatus including: at least a first light guide adapted to be disposed between an illumination source and a top of one of the plurality of vertical sample wells; and at least a second light guide adapted to be disposed between at least a first detector and the top of one of the plurality of vertical sample wells.

### CROSS-REFERENCE TO RELATED APPLICATION

The present application claims the benefit of the filing date of U.S. Provisional Patent Application No. 60/190,189, filed Mar. 17, 2000, and titled ULTRAHIGH THROUGHPUT FLUORESCENT SCREENING.

### BACKGROUND OF THE INVENTION

1. Field of the Invention

The present invention relates to laboratory screening generally and, more particularly, but not by way of limitation, to a novel ultrahigh throughput fluorescent screening apparatus and method.

2. Background Art

Fluorescence is a very sensitive and widely used modality in many laboratory measurement systems. Fluorescing molecules (fluorophores) occur in nature or may be synthesized in the laboratory. In biological applications, these fluorescence molecules are applied to tags designed to match specific receptor sites on the molecules of interest. By exciting these tags with specific wavelengths of light, the fluorophores emit longer wavelengths that may then be detected by sensitive optical measuring instruments. Most such measurements currently use laboratory test tubes, cuvettes, or 96-well microtiter plates for holding the samples to be measured. The volumes of such samples are usually greater than 50 microliters each and up to several hundred microliters each.

In many research and clinical applications, the cost of analyzing a large number of samples using expensive reagents in these sample volumes has become prohibitive. The sample preparation and instrument industries are addressing these concerns by making smaller, more densely packed sample wells. Currently, 384 sample wells (16 per row by 24 rows are being formed into the area of a 96-well microtiter plate. However, the configuration of these deep wells still requires sample volumes of 20 microliters or greater.

As the number of tests being run increases, greater demands are also being made on the throughput of the instruments. Some applications require on the order of 100,000 samples to be run in a 24-hour period. Instrument makers have responded to this demand by measuring the entire microplate at one time using video imaging techniques While this technology may be adequate for relatively high fluorescent reactions with large sample volumes, it is not sufficiently sensitive for smaller sample volumes or samples having lower fluorescent activity.

Furthermore, the deep wells and narrow entrances of the currently designed plates limit the types of measurements that can be made. Generally, the wells must be excited from one side of the plate and read from the other side through transparent well bottoms. The walls between wells must be opaque to eliminate cross talk. They are therefore generally limited to single wavelength fluorescence intensity measurements. Fluorescence polarization measurements are possible, but only with two sequential measurements and if the clear well bottoms do not depolarize the emitted light. Similarly, dual wavelength measurements such as fluorescent resonance energy transfer also require sequential measurements, which greatly increases measurement times and thus reduces throughput.

The primary determining factors of the detection limits for optical instruments such as fluorometers are: (i) the detector's intrinsic sensitivity and gain, (ii) the dimensional area of the detector, and (iii) its proximity to the photon emitter. The ideal detector would be a photon sensing, electron multiplying sphere surrounding the light emitting sample.

In practical terms, detectors are planar surfaces with finite dimensional limits. The amount of light detected is a fraction defined as the ratio of the detector area to that of the area of a sphere with a radius equal to the distance between the source and the detector. For a given detector area, the amount of photon energy intercepted obeys the well known “inverse square law”, wherein the detection limit diminishes as the square of the distance to the source.

Instrument designers have traditionally placed photon detectors in proximity to the samples or have used light guides in proximity to the source to capture as much light as possible and efficiently transport it to the detector. As sample sizes have diminished, this latter method has become increasingly prevalent. The effective aperture for capturing light is the area of the end of the light guide near the fluorescent source.

Similarly, the excitation illumination of fluorescent samples obeys the same inverse square law wherein the lamp functions as a point source and the illumination intensity diminishes as the square of the distance to the sample. Lamp designers often utilize spherical mirrors to capture and project more of the emitted light onto the area of interest.

If a fluorescent reaction takes place within a standard glass or plastic test tube or cuvette, the detector may be placed in proximity thereto. A mirror may be placed on the side of the tube opposite the detector to capture more of the emitted light. This configuration, using a photon sensing photomultiplier type detector, demonstrates improved detection limits, but is limited to individual sample measurements. It is therefore not useful where high throughputs are demanded.

Fluorescent polarization measurements are traditionally made using glass cuvettes with detectors disposed at 90° to the excitation illumination. An alternative configuration used in some instruments is the use of a rotating polarization analyzer filter. Two measurements are made sequentially, first for one spatial component (e.g., vertical component) followed by the analyzer filter being rotated by 90° (horizontal component) for the second measurement. Such a sequence takes more than twice the measurement time per sample than a single measurement.

To illuminate all the wells of a 384-deep-well microplate without shadowing, the illumination source must be at least three feet above the microplate. Visualization of the microplate requires that a CCD camera be about one-and-one-half feet below the plate. Such a configuration results in a very energy inefficient design and therefore relatively poor sensitivity.

To improve efficiency and therefore light sensitivity, fiber optics may be employed to efficiently transmit light from the illumination source to the sample plate. Wells with transparent bottoms allow the emitted light to reach the detector. Wavelength limiting filters separate the excitation wavelengths from those emitted by the fluorescent molecules. This configuration is several orders of magnitude more sensitive than the type of device described above that illuminates the entire plate. However, the measurements must be made one well at a time and either the detector and fiber optics or the sample plate moved from well to well. Even if multiple detector/light guide assemblies are used, the sample plate must be moved precisely in two directions.

Accordingly, it is a principal object of the present invention to provide fluorescent screening apparatus and method that can handle ultrahigh sample throughputs.

It is a further object of the invention to provide such apparatus and method that can handle small sample volumes.

It is an additional object of the invention to provide such apparatus and method that have high detection sensitivity with wide dynamic range.

It is another object of the invention to provide such apparatus and method that have multi-modality operation.

It is yet a further object of the invention to provide such an apparatus that has simple and reliable sample handling mechanisms.

Other objects of the present invention, as well as particular features, elements, and advantages thereof, will be elucidated in, or be apparent from, the following description and the accompanying drawing figure.

### SUMMARY OF THE INVENTION

The present invention achieves the above objects, among others, by providing, in a preferred embodiment, an ultrahigh throughput fluorescent screening apparatus for a microplate having a plurality of vertical sample wells, said apparatus comprising: at least a first light guide adapted to be disposed between an illumination source and a top of one of said plurality of vertical sample wells; and at least a second light guide adapted to be disposed between at least a first detector and said top of one of said plurality of vertical sample wells.

### BRIEF DESCRIPTION OF THE DRAWING

Understanding of the present invention and the various aspects thereof will be facilitated by reference to the accompanying drawing figures, provided for purposes of illustration only and not intended to define the scope of the invention, on which:

FIG. 1 is a schematic side elevational view of a conventional fluorescence measurement system.

FIG. 2 is a schematic side elevational view of a conventional fluorescence measurement system using a mirror placed on one side of a sample tube.

FIG. 3 is a schematic diagram of a conventional fluorescence measurement system using a rotating polarizing filter.

FIG. 4 is a fragmentary, schematic side elevational view of a conventional fluorescence measurement system in which an entire microplate is illuminated.

FIG. 5 is a schematic side elevational view of a conventional fluorescence measurement system using fiber optics.

FIG. 6 is a schematic side elevational view, partially in cross-section, of one embodiment of the present invention.

FIG. 7 is a schematic side elevational view, partially in cross-section, of another embodiment of the present invention.

FIG. 8 is a schematic top plan view of a further embodiment of the present invention.

### DETAILED DESCRIPTION OF THE PREFERRED EMBODIMENTS

Reference should now be made to the drawing figures on which similar or identical elements are given consistent identifying numerals throughout the various figures thereof, and on which parenthetical references to figure numbers direct the reader to the view(s) on which the element(s) being described is (are) best seen, although the element(s) may be seen on other figures also.

FIG. 1 is a simplified diagram of a basic fluorescence intensity measuring system, generally indicated by the reference numeral 20. System 20 includes a sample 30 containing a fluorescent tag (not separately indicated) disposed in a cuvette or test tube 32. An excitation filter 40 adjacent a broadband illumination source 42 passes excitation wavelengths 44 which illuminate sample 30 and excite the fluorescent molecules therein to a higher energy state. When a fluorophore returns to its ground state, it emits light photons of a longer wavelength. An emission filter 50 separates the light by blocking the shorter excitation wavelengths 44 and passing the longer emission wavelengths 52 to a detector 54. Detector 54 then provides an output signal representative of the strength of emission wavelengths 52.

FIG. 2 illustrates a sample 60 containing a fluorescent tag disposed in a cuvette or test tube 62. A photomultiplier detector 70 is disposed in proximity to one side of test tube 62 and a mirror 72 is disposed on the other side of the test tube to capture more of the emitted light. As noted above, this arrangement demonstrates excellent detection, but is limited to individual sample measurements and is not suitable where high throughputs are demanded.

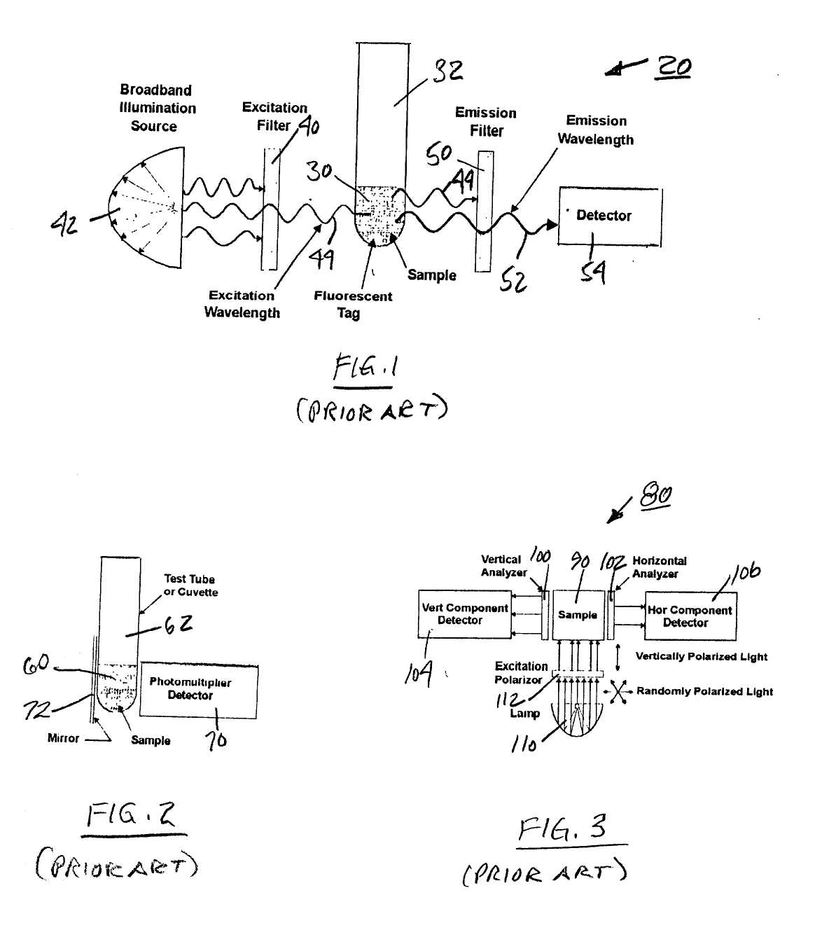

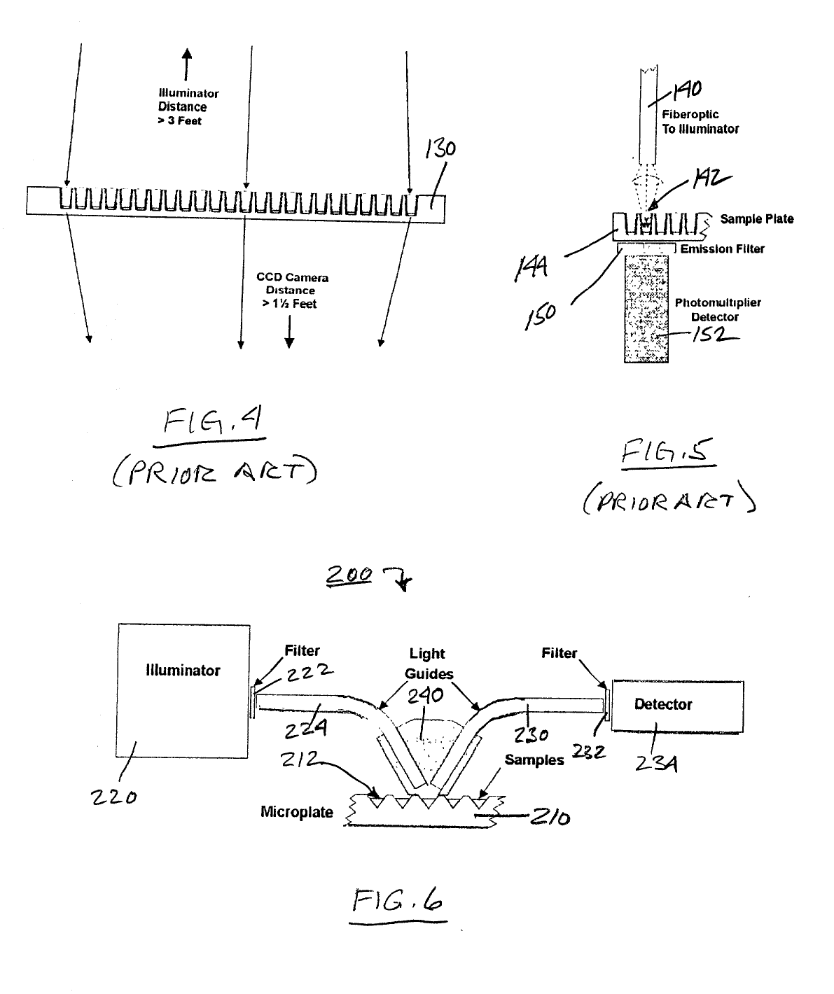

FIG. 3 illustrates one traditional polarization system, generally indicated by the reference numeral 80 that includes a sample disposed in a cuvette 90. Vertical and horizontal analyzers 100 and 102, respectively, are disposed adjacent cuvette 90 and the outputs thereof are transmitted to vertical and horizontal component detectors 104 and 106. Illumination from a lamp 110 is transmitted to cuvette 90 through an excitation polarizor 112. As indicated on FIG. 3, excitation polarizor 112 is arranged such that vertically polarized light illuminates cuvette 90 and vertical component detector 104 receives an output from vertical analyzer 100. Once that measurement is made, excitation polarizor 112 is rotated 90° and horizontal component analyzer 106 is used to make a second measurement. As noted above, such a sequence takes twice the measurement time per sample as does a single measurement.

FIG. 4 illustrates an arrangement wherein an entire 384-well microplate 130 is illuminated by a light source (not shown) placed at some distance above the microplate and an imaging detector (not shown) is placed below the microplate. As noted above, this arrangement has the disadvantage that it is very energy inefficient and, therefore, has inadequate sensitivity for low volumes.

FIG. 5 illustrates an arrangement with improved efficiency and light sensitivity. Here, a fiber optic guide 140 in conjunction with an illuminator (not shown) illuminates a clear-bottom well 142 in a sample plate 144. An emission filter 150 and a photomultiplier detector disposed underneath well 142 “read” the emitted light. As noted above, this arrangement suffers from the disadvantage that, even if multiple detector/light guide assemblies are used, sample plate 144 must be moved precisely in two directions. This design also requires wide, flat, transparent well bottoms.

FIG. 6 illustrates a system, according to one embodiment of the present invention, and generally indicated by the reference numeral 200. System 200 employs a horizontal microplate 210 having a plurality of shallow, vertical, open wells, as at 212, each well including sloped sides, such that each well imay be generally V-shaped. Transparent well bottoms are not required, reducing the cost of disposables. Shallow wells 212 conserve the volume of reagents used. Sample in a well 212 is excited by light transmitted from an illuminator 220 and excitation filter 222 by a first square light guide 224. An end of first light guide 224 is in proximity to well 212 and efficiently illuminates the fluorescent molecules. An end of a second square light guide 230 is in proximity to well 212 and efficiently transmits emitted light to an emission filter 232 and a detector 234. A light shield 240 disposed around the ends of first and second light guides 224 and 230 in proximity to well 212 blocks the transmission of light therebetween, thus increasing the signal-to-noise ratio. Using this arrangement, relatively high overall optical efficiency is attained. This configuration is capable of fairly high throughput screening limited to fluorescence intensity and time or frequency resolved measurement modalities. Dual wavelength and fluorescence polarization methods require two sequential read cycles. Therefore, high throughput, multi-modality operation is not fully realized with this arrangement.

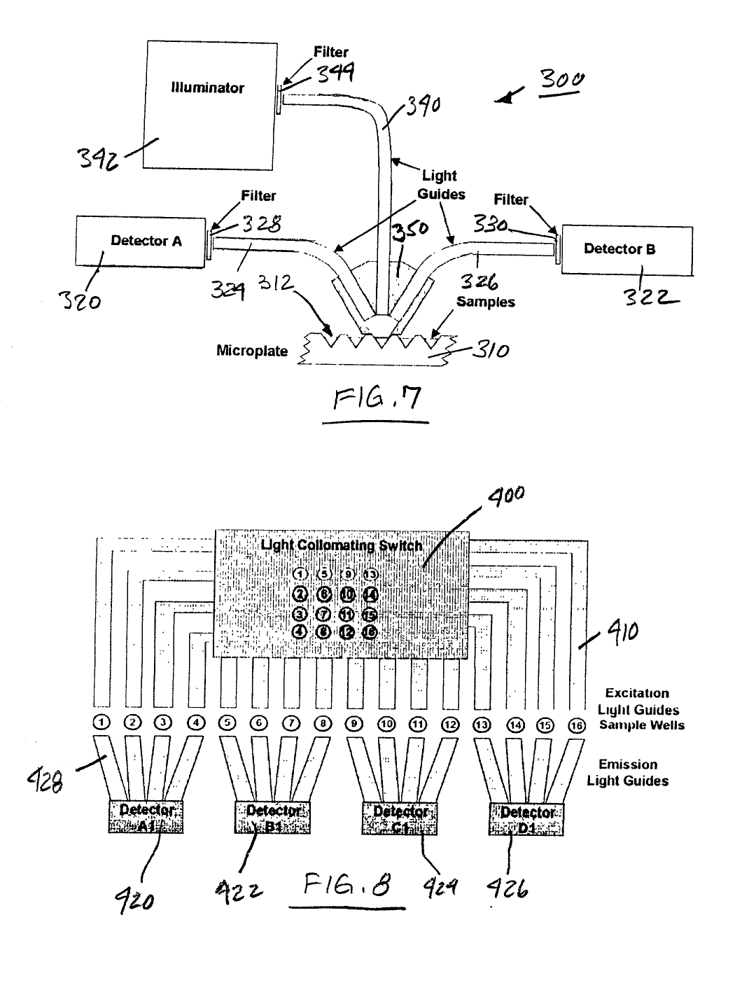

FIG. 7 illustrates a system according to another embodiment of the present invention, and generally indicated by the reference numeral 300. System 300 includes a horizontal microplate 310 having a plurality of vertical, open wells, as at 312, similar to microplate 210 and wells 212 (FIG. 6). First and second detectors 320 and 322 simultaneously measure two independent aspects of the fluorescent emissions through, respectively, first and second square light guides 324 and 326 and first and second separation filters, or polarization analyzers, 328 and 330. This arrangement permits multiple wavelength measurements such as fluorescence resonance energy transfer or dual tagging of molecules. Excitation is achieved by means of a high efficiency third square light guide 340 having one end in proximity to an illuminator 342 and an excitation filter 344. First, second, and third light guides 324, 326, and 340 have ends in proximity to the sample in a well 312 and the ends thereof are separated by a light shield 350 to increase the signal-to-noise ratio. First, second, and third light guides are of the type that maintain the light polarization properties, as discussed in U.S. Pat. No. 5,692,091, issued Nov. 25, 1997, and titled COMPACT OPTICAL COUPLING SYSTEM, the disclosure of which is incorporated by reference hereinto. High optical efficiency resulting in excellent detection limits is achieved by matching first and second light guides 324 and 326 with sensitive first and second detectors 320 and 322. Avalanche diodes or photomultiplier type detectors may be used in either the current mode or photon counting mode. Due to the relatively small amount of fluorescence activity in the small sample sizes involved, photon counting methods may have an advantage.

To achieve true ultrahigh throughput of 100,000 samples per day, simultaneous measurement of multiple wells is required. For instance, in the case of 16 samples in one row of a microplate, the throughput rate may be doubled by using two measurement heads; quadrupled with four, etc, up to 16 measurement stations. In this example, a balance of cost vs. throughput is achieved using four, dual detector measuring sites for a 16×24, 384-well microplate. Several methods of aligning the excitation and detector light guides with the sample wells are possible. A detector head having multiple detector stations may be moved from one sample set to another along a row. Alternatively, the sample plate could be moved in a sideways motion under a fixed detector head assembly.

FIG. 8 illustrates a preferred embodiment using a light multiplexing switch 400 to sequentially excite and measure several samples simultaneously without relying on sample plate or detector head motion. A plurality of excitation light guides, as at 410, are connected by switch 400 to an illumination source (not shown) and to selected ones of wells 1-16. Four detector pairs 420, 422, 424, and 426 (only one of each pair shown) each has eight emission light guides, as at 428 (only four shown), disposed between it and a selected four of wells 1-16. In the example shown, switch 400 illuminates sample wells 1, 5, 9, and 13 simultaneously. Detector pair A reads sample well 1, detector pair B reads sample well 5, detector pair C reads sample well 9, and detector pair D reads sample well 13. Switch 400 then causes sample wells 2, 6, 10, and 14 tp be illuminated simultaneously. This time, detector pair A reads sample well 2, detector pair B reads sample well 6, etc. For a one-second read time plus 1/4 second for the selection of switch 400, the reading of a row of 16 wells could be completed in five seconds and a 384-well microplate could be read in about two minutes. While detector pairs 420, 422, 424, and 426 each has two detector modules, only one detector module may be employed as in system 200 (FIG. 6), although with a lessening of the full power of the invention.

The invention described provides a measurement method and instrument design that is both highly sensitive and fast. It as sufficient sensitivity to read small sample volumes and is capable of reading 100,000 fluorescence intensity samples per day. In addition, the multiple detector configuration described in this technique results in a highly flexible, multi-modality instrument not otherwise possible.

The fluorescence measurement methods described above may be used in any sample tube, well, or plate configuration, but is especially effective in an array of shallow, small volume wells. It is not necessary to provide transparent well bottoms, as all excitation and measurements may be made from the top of the microplate. The array used in this description has, but is not limited to, 16 wells per row with 24 rows for a total of 384 sample wells per array. For convenience in handling, this array is placed within the dimensions of the industry standard 96-well microtiter plate.

Terms such as “upper”, “lower”, “inner”, “outer”, “inwardly”, “outwardly”, “vertical”, “horizontal”, and the like, when used herein, refer to the positions of the respective elements shown on the accompanying drawing figures and the present invention is not necessarily limited to such positions.

It will thus be seen that the objects set forth above, among those elucidated in, or made apparent from, the preceding description, are efficiently attained and, since certain changes may be made in the above construction without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said to fall therebetween.

The embodiments of the invention in which an exclusive property or privilege is claimed are defined as follows:

1. A high or ultrahigh throughput fluorescent screening apparatus for a microplate having a plurality of vertical sample wells, said apparatus comprising:
(a) at least a first light guide adapted to be disposed between an illumination source and a top of one of said plurality of vertical sample wells; and
(b) at least a second light guide adapted to be disposed between at least a first detector and said top of one of said plurality of vertical sample wells.

2. A high or ultrahigh throughput fluorescent screening apparatus for a microplate having a plurality of vertical sample wells, as defined in claim 1, wherein: each of said plurality of vertical sample wells has sloped sides, such that said each of said plurality of vertical sample wells is generally V-shaped.

3. A high or ultrahigh throughput fluorescent screening apparatus for a microplate having a plurality of vertical sample wells, as defined in claim 1, further comprising: a third light guide adapted to be disposed between a second detector and said top of one of said plurality of vertical sample wells.

4. A high or ultrahigh throughput fluorescent screening apparatus for a microplate having a plurality of vertical sample wells, as defined in claim 3, further comprising: a light multiplexing switch adapted to be disposed between said illumination source and a selected two of said plurality of vertical sample wells.

5. A high or ultrahigh throughput fluorescent screening apparatus for a microplate having a plurality of vertical sample wells, as defined in claim 1, wherein: said wells are open.

6. A method of ultrahigh throughput fluorescent screening, comprising:
(a) providing a microplate having a plurality of vertical sample wells;
(b) providing excitation illumination to one of said plurality of vertical sample wells at a top thereof; and
(c) detecting emission light from said one of said plurality of vertical sample wells at a top thereof.
